(19) United States
(12) Patent Application Publication
(10) Pub. No.: US 2021/0304630 A1
(43) Pub. Date: Sep. 30, 2021

(54) INTERPRETABLE MACHINE LEARNING ALGORITHMS FOR IDENTIFYING AT-RISK STUDENTS IN ONLINE DEGREE PROGRAMS

(71) Applicant: Coursera, Inc., Mountain View, CA (US)

(72) Inventors: Alan Hickey, Palo Alto, CA (US); Xiao Yang, San Carlos, CA (US); Marianne Sorba, Calabasas, CA (US)

(21) Appl. No.: 17/301,145

(22) Filed: Mar. 26, 2021

Related U.S. Application Data
(60) Provisional application No. 63/000,932, filed on Mar. 27, 2020.

(51) Int. Cl. G09B 5/08; G06N 20/00; G06Q 50/20

(52) U.S. Cl. CPC G09B 5/08; G06Q 50/205; G06N 20/00

(57) ABSTRACT

Described systems and techniques provide actionable insights to enable student support staff to identify students who are in need of support, even when such students have not requested support. Fast and accurate training of multiple machine learning models may be implemented to enable iterative, updateable predictions of a student's grade in a course, even when the course has never been previously offered to students. As a student progresses through a course and towards a degree that requires that course, described techniques may update a predicted final course grade of that student, using one or more trained, selected machine learning models.

### CROSS-REFERENCE TO RELATED APPLICATION

This application claims the benefit of U.S. Application No. 63/000,932 filed on Mar. 27, 2020, entitled “Interpretable Machine Learning Algorithms for Identifying At-Risk Students in Online Degree Programs” and which is incorporated by reference in its entirety herein.

### TECHNICAL FIELD

This description relates to online learning.

### BACKGROUND

Online learning provides many opportunities for learning that would not otherwise be feasible or available for many students, and that allow students to learn in their preferred manners. For example, online learning platforms are scalable to reach large numbers of students across many geographical areas.

When scaled to reach large numbers of students, however, it becomes difficult to provide sufficient student support. For example, if an online learning platform provides many different courses, and each course enrolls thousands of students, it becomes impractical to provide a sufficient number of support personnel to provide support to the enrolled students.

### SUMMARY

According to one general aspect, a computer program product may be tangibly embodied on a non-transitory computer-readable storage medium and may include instructions that, when executed by at least one computing device, are configured to cause the at least one computing device to determine a student in an online course, the online course occurring over a period of time, the online course including learning items and a grading structure used to grade at least some of the learning items. When executed, the instructions may further cause the at least one computing device to determine a course-specific machine learning model trained using the grading structure and enrollment features characterizing student interactions with the learning items, and determine feature values of the enrollment features, based on student interactions of the student with the learning items as of a prediction time within the period of time. When executed, the instructions may further cause the at least one computing device to generate a prediction of a course grade of the student as of the prediction time for the online course, using the feature values and the course-specific machine learning model.

According to another general aspect, a computer-implemented method may include determining a student in an online course, the online course occurring over a period of time, the online course including learning items and a grading structure used to grade at least some of the learning items, and determining a course-specific machine learning model trained using the grading structure and enrollment features characterizing student interactions with the learning items. The method may include determining feature values of the enrollment features, based on student interactions of the student with the learning items as of a prediction time within the period of time, and generating a prediction of a course grade of the student as of the prediction time for the online course, using the feature values and the course-specific machine learning model.

According to another general aspect, a system may include at least one memory including instructions, and at least one processor that is operably coupled to the at least one memory and that is arranged and configured to execute instructions. When executed, the instructions may further cause the at least one processor to determine a student in an online course, the online course occurring over a period of time, the online course including learning items and a grading structure used to grade at least some of the learning items, and determine a course-specific machine learning model trained using the grading structure and enrollment features characterizing student interactions with the learning items. When executed, the instructions may further cause the at least one processor to determine feature values of the enrollment features, based on student interactions of the student with the learning items as of a prediction time within the period of time, and generate a prediction of a course grade of the student as of the prediction time for the online course, using the feature values and the course-specific machine learning model.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for providing student support using interpretable machine learning models.

FIG. 2 is a flowchart illustrating example operations of the monitoring system of FIG. 1.

FIG. 3 is a flowchart illustrating example operations of a feature selection process for training course-specific machine learning models of the system of FIG. 1.

FIG. 4 is a flowchart illustrating example operations of a course selection process for training course-specific machine learning models of the system of FIG. 1.

FIG. 5 is a graph illustrating course grade distributions that may be used during the example operations of FIG. 4.

FIG. 6 is a graph illustrating grading event distributions that may be used during the example operations of FIG. 4.

FIG. 7 is graph illustrating selected and non-selected courses during the example operations of FIG. 4.

FIG. 8 is a flowchart illustrating more detailed examples of daily operations of the system of FIG. 1.

FIG. 9 is a graph illustrating a feature selection process for identifying areas of student support based on operations of a course-specific machine learning model in predicting a student's course grade.

FIG. 10 is an example screenshot of a graphical user interface that may be used in the system of FIG. 1.

FIG. 11 is a graph illustrating a progression of grade predictions in conjunction with progression of a related course.

FIG. 12 is a graph illustrating an example correlation between a student's grade and a likelihood of the student returning for a subsequent term.

### DETAILED DESCRIPTION

Described systems and techniques provide actionable insights to enable student support staff to identify students who are in need of support, even when such students have not requested support. With such insights, the student support staff may be provided with specific, per-student guidance for assisting identified students. As a result, for example, students are more likely to proceed successfully through a course. Moreover, an online learning platform providing courses to the students is more likely to provide successful instruction, including successfully advancing students to completion of desired degrees.

In providing the above features and advantages, described systems and techniques enable fast and accurate training of multiple machine learning models, thereby enabling iterative, updateable predictions of a student's grade in a course, even when the course has never been previously offered to students. For example, as a student progresses day-by-day through a course and towards a degree that requires that course, described techniques may update a predicted final course grade of that student each day of instruction, using one or more trained, selected machine learning models.

Moreover, when the predicted grade is below a threshold, or includes some other deficiency, described techniques provide support staff with specific reasons as to why such deficiencies exist. Consequently, in example embodiments, described techniques are able to provide support staff with specific action items to take to assist identified students. In other examples, described systems may be configured to send specific, personalized, automated support messages, or other information, to students identified as needing support.

As a result, for example, it is possible to provide online learning classes to thousands or millions of students, including providing new and updated courses on a regular basis, and to provide successful support for all of the students, even with a minimal number of support staff. Further, the minimal number of support staff may require minimal training as compared to conventional techniques of providing support, since, for example, the support staff may be relieved of a need to be trained to anticipate or interpret student support needs by the automated techniques used herein.

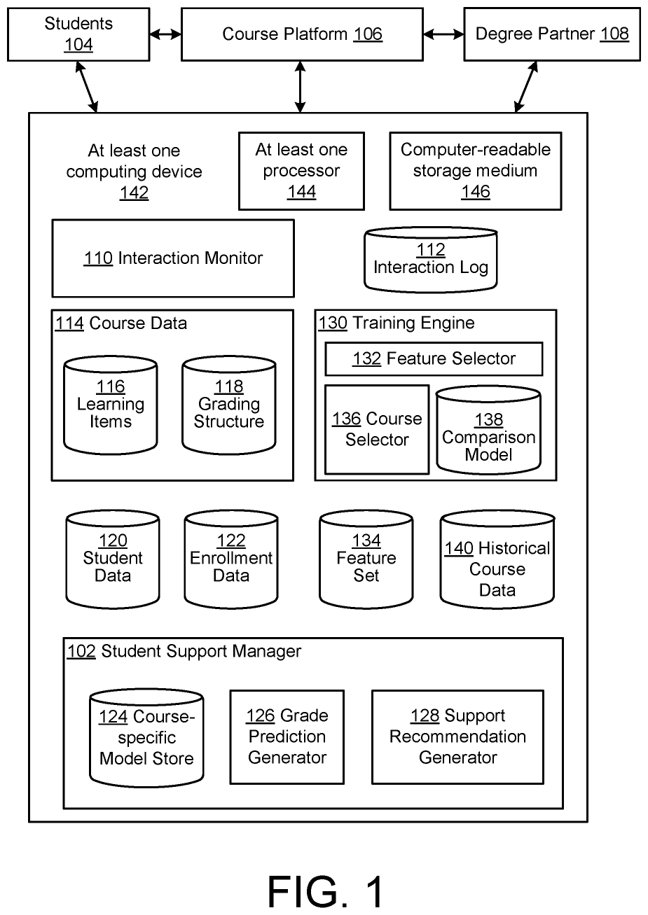

FIG. 1 is a block diagram of a system for providing student support using interpretable machine learning models. In the example of FIG. 1, a student support manager 102 is configured to provide and enable support for a large plurality of students 104, who are being provided with online learning opportunities using a course platform 106. As referenced above, and described in detail below, the student support manager 102 may be configured to use multiple course-specific machine learning models to predict a course grade of a particular student of the students 104, even when the course platform 106 is providing courses to very large numbers of students.

The student support manager 102 may be configured to provide student support in very specific, actionable ways, even when a course has never been offered previously. For example, the student support manager 102 may predict a final grade of a student in a course, during or for each day of instruction of the student in the course. Consequently, the student support manager 102 may identify a specific day at which a student begins to require support, and may identify patterns in daily grade predictions that indicate support may be needed in the future (or that previously-provided support has had an intended effect of raising a predicted grade).

Moreover, the student support manager 102 may provide specific areas of assistance for each student, which are determined to be most likely to have a large impact on improving the final grade of the student. For example, the student support manager 102 may determine that a first student would improve their predicted grade by being more timely in completing assignments, while a second student would improve their predicted grade by participating more during instruction periods.

In FIG. 1, the course platform 106 may be provided by any suitable online course provider. As such, the course platform 106 may include any suitable number of servers (e.g., application servers, web servers, or database servers) and related hardware and software, distributed geographically as needed to provide instruction to the various students 104.

The system of FIG. 1 may provide student support, including grade predictions, for virtually any implementation of the course platform 106. Consequently, the course platform 106 is not described here in detail, except as may be helpful in understanding operations of the student support manager 102 and other components of the system 100.

Nonetheless, by way of overview and non-limiting example, it will be appreciated that the course platform 106 may provide many types of instructional content, including textual, audio, or video content, which may be provided passively or actively. For example, in the latter case, the course platform 106 may enable instructors to interact with students during real-time, synchronous class periods.

The course platform 106 may also be configured to provide many types of infrastructure and logistical support for providing instructional content. For example, the course platform 106 may handle the logistics of student enrollment, profiles, and attendance. The course platform 106 may provide infrastructure for testing, grading, and tracking a student's progress in the context of working towards a degree. The course platform 106 may provide various other types of infrastructure for authoring new courses, and otherwise managing a administering a course catalogue.

Thus, the course platform 106 may facilitate or provide instruction to an individual student of the students 104 that ranges from individual lessons on specific topics, to multi-year degree programs. In various implementations described herein, the platform and related infrastructure provided by the course platform 106 may be used by a degree partner 108 to offer course content in a manner that leverages respective strengths of each of the course platform 106 and the degree partner 108.

For example, the degree partner 108 may represent a university or other academic institution. As such, the degree partner 108 may have many unique offerings in terms of instructors and associated degree programs, and included content.

It may be difficult, however, for the degree partner to administer such offerings on a large scale to the students 104. Therefore, the degree partner 108 may utilize the availability and strengths of the course platform 106 to distribute and administer course content.

Similarly, the degree partner 108 may represent other entities wishing to administer instruction. For example, the degree partner 108 may represent a business or governmental entity interested in administering relevant educational content, including certification of the students 104 as having successfully received such educational content.

Although the system of FIG. 1 may be implemented using either or both of the course platform 106 and the degree partner 108, neither entity will typically be willing or able to provide sufficient support staff to provide adequate support to the students 104. In conventional settings, such support staff personnel would be expected to have knowledge of course content, and to track students' progress in attempting to successfully learn the course content. Particularly for large numbers of the students 104, providing sufficient levels of such support using conventional techniques is not a feasible or desirable solution.

In the system of FIG. 1, an interaction monitor 110 is configured to monitor any and all interactions of the students 104, the course platform 106, and the degree partner 108. In FIG. 1, the interactions are illustrated as being stored using an interaction log 112.

Many examples of such interactions are referenced above, and described below in additional detail, or would be apparent to one of skill in the art. For example, interactions may be logged with respect to any of the infrastructure features described above, such as creating and maintaining student profiles, or authoring and administering courses.

Further in FIG. 1, course data 114 refers to content related to a particular course of instruction that may be administered by the course platform 106 and/or the degree partner 108. In the present description, a course should be understood to refer to any group of individual classes or sessions, and related instructional material, that are related to a topic of instruction and that are collectively evaluated (e.g., graded) by one or more instructors.

For example, a course may refer to recurring, scheduled classes related to a particular academic subject, and that occur over the course of an academic semester or year, and for which a single cumulative course grade is provided. Successful completion of multiple related courses may be defined with respect to achieving a degree from the degree partner 108.

An individual course may include classes scheduled on defined weekdays, at defined times. In other examples, course scheduling may be more flexible, e.g., courses may be asynchronous or on-demand. For example, a course may be defined as including a number of classes, and a student may progress on their own schedule(s) through the included classes.

The course data 114 is therefore illustrated as including learning items 116, as well as a grading structure 118. That is, the course data 114 should be understood to refer to, or include, static (or infrequently updated) data that describes how the related course is administered to any of the students 104 taking the course in question.

For example, the learning items 116 may include any content used by students or teachers during the administration of the related course, such as tests, instructional videos, or reading material. Accordingly, the learning items 116 may be associated with various characteristics, such as related deadlines. As described below, some of the learning items 116 may be graded, while others may be ungraded.

The grading structure 118 refers to a manner in which grades assigned to graded ones of the learning items 116 are administered and aggregated to determine a course grade for the course, which may include or refer to a final grade of the course. For example, the grading structure 118 may include weights assigned to each graded learning item, or type of learning item, for purposes of calculating a final or cumulative grade. The grading structure 118 may also include parameters for evaluating individual grades, such as how to penalize late or overdue assignments when assigning a grade thereto.

Student data 120 refers to stored data related to individual ones of the students 104. The student data 120 may include student profile or account data, demographic data, and course history data. Similar to the course data 114, the student data is updated relatively infrequently, e.g., as a student completes a course or degree.

Enrollment data 122 refers to data related to individual students enrolled in individual courses. For example, the enrollment data 122 may be considered to include data at an intersection of the course data 114 and the student data 120. For example, the enrollment data 122 may include, for a particular test of the learning items 116 and a particular student of the students 104 as characterized and included in the student data 120, a score or grade received by the particular student.

More generally, the enrollment data 122 includes all progress of individual students in individual courses. As such, the enrollment data 122 may typically be updated frequently, e.g., daily, or multiple times per day, or as individual classes are administered.

For example, as the students 104 take tests or complete assignments or other activities administered by the course platform 106 on behalf of the degree partner 108, the interaction monitor 110 may automatically track and log related data within the interaction log. The enrollment data 122 may thus represent or include a subset of the logged interaction data, which may be categorized, characterized, or otherwise stored in any desired manner. Further, the enrollment data 122 may be used by the student support manager 102 to provide the types of grade predictions and associated student support referenced above.

For example, the student support manager 102 is illustrated as including a course-specific model store of machine learning models that may be used by a grade prediction generator 126 to predict a course grade for an individual student in an individual course. As referenced above, and described in detail, below, the machine learning models, as trained, generate, and used herein, enable the grade prediction generator 126 to generate a grade prediction for an enrolled student in a course quickly and easily, and as many times as needed during a progression of the course in question.

Then, a support recommendation generator 128 may be configured to identify, from the course-specific machine learning models 124 and the predicted grades, specific, actionable support recommendations that are determined to provide a most efficient, effective, and achievable action(s) to be taken by the student to improve the predicted course grade. Moreover, such support recommendations may only be provided in response to the predicted grade being below a defined threshold, or in response to some other trigger. Consequently, limited support resources may be focused on students most in need of assistance.

For example, two students may take the same course and receive a low predicted course grade at a given point in time. The support recommendation generator 128 may determine that the first student has a low predicted grade with excessive late assignments, while the second student is determined to have a low predicted grade primarily with low class participation. Subsequent support efforts may then be targeted accordingly to address these individual deficiencies, with an expectation that doing so will result in a higher grade prediction, and, ultimately, in a higher course grade being achieved.

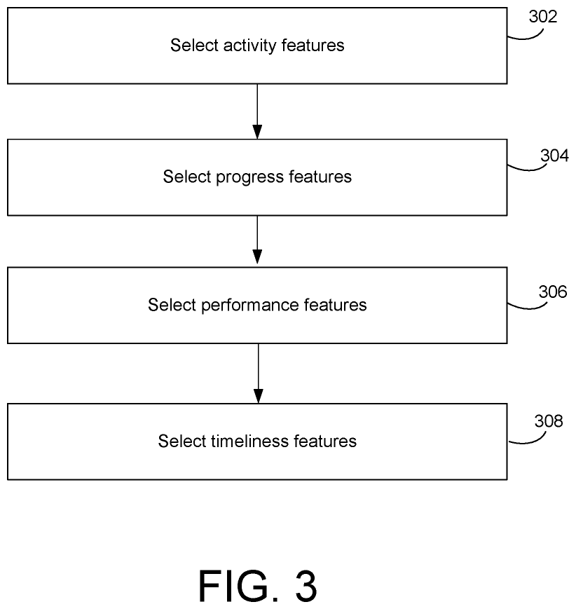

In order to support operations of the student support manager 102, a training engine 130 is configured to train the course-specific models in the course-specific model store 124 for use by the grade prediction generator 126. For example, as described in detail below with respect to FIG. 3, the training engine 130 may include a feature selector 132 that is configured to select a feature set 134 that includes identified enrollment features to use in training a new course-specific model for an identified course.

For example, enrollment features may refer to and include features defined by student interactions with the learning items 116 and/or the grading structure 118 of the course data 114. For example, such enrollment features may include activity features characterizing an extent of course activity of a student (independent of results of such activity), progress features characterizing an extent of progress of each student with respect to individual learning items, performance features characterizing an extent of success of a student in terms of performance evaluations (e.g., grades), or timeliness features characterizing a manner and extent to which a student performs relative to deadlines or other goals. Specific values of enrollment features (that is, for specific students) may then be scored or otherwise utilized with the corresponding course-specific model by the grade prediction generator 126.

The above-referenced enrollment features are merely examples of the many types of features that may be identified, characterized, and used during training by the training engine 130. As discussed below, such enrollment features may be selected for training based on a level of success anticipated to be achieved in performing grade predictions using such enrollment features. For example, administrators may choose enrollment features based on experience. In additional or alternative implementations, many combinations of enrollment features may be tested using historical data, so that best-available enrollment features may be selected as a result of such testing.

In example implementations, the feature set 134 is expansive and inclusive enough to capture a sufficient number and variety of enrollment features to train a course-specific model for a corresponding course, across all students enrolled in that course. Then, it may occur that different subsets of the selected features are meaningfully predictive for individual students. Within each such subset of enrollment features predictive for a particular student, it may occur that only a small number of the subset of enrollment features account for a significant impact on the course grade predicted for that student. Consequently, the support recommendation generator 128 may be configured to identify such impactful enrollment features, to use as a basis for generating support recommendations.

In some implementations, to train a course-specific model, previous enrollments of the course in question may be used. For example, a course that has been taught multiple times during preceding semesters may provide sufficient training data.

In many cases, however, such training data is not available, or not sufficient, to conduct desired levels of training. For example, a course may be newly-offered, or may be non-trivially or significantly changed since previous administrations of the course were completed.

For example, an instructor may simply decide to reorganize a course to teach similar material in a different order, or using different source material, or using a different grading structure. Since course-specific models may be trained to predict a course grade for a user, e.g., a final course grade, multiple times as the course progresses (e.g., daily, when course sessions are offered daily), such changes in course structure may significantly reduce an effectiveness of a resulting model.

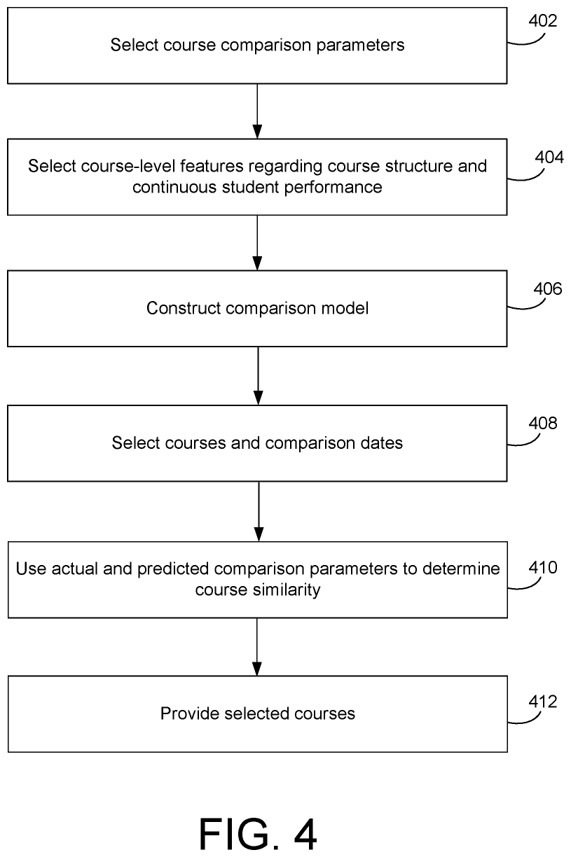

In the system of FIG. 1, the training engine 130 includes a course selector 136 that may be configured to select sufficiently similar courses for use in training a course-specific model for a specific course in question. Example operations of the course selector 136 are provided below, e.g., in conjunction with FIGS. 4-7. In general, however, the course selector 136 may be configured to utilize machine learning, e.g., use a comparison model 138, to select sufficiently similar courses from historical course data 140.

In this regard, and as discussed below, the historical course data 140 includes courses that have already been completed, in whole or in part, and such historical data may include types of enrollment data at the course (not necessarily student) level. For example, a particular grade of a particular student in a course may be considered enrollment data for that student, but a grade distribution of an entire class of students during a specific administration of a course may be included in the historical course data 140.

Using these techniques, for example, the system of FIG. 1 may train and generate a new course-specific model, and use the resulting model to predict a grade for each student, in between each class or session of a course. For example, following a class session that is number 10 of 20 total classes in a course, the training engine 130 may utilize the course selector 136 to select similar courses, and, in particular, may select a course that is similar as of a corresponding class (for example, may select a course having 20 sessions that is sufficiently similar as of class 10, or may select a course that is similar as of a day that is 50% of a way to completion of that course). The selected course(s) may then be used to train a course-specific model, which may then be used by the grade prediction generator 126 to generate a grade prediction for a course grade at the end of the 20th (final) class session.

Then, following a subsequent class session that is number 11 of 20 total classes, some or all of the entire process may be repeated. For example, a new course selection process may be performed, which may result in the same or different courses being selected. For example, this course selection may be influenced by events occurring during the 11th class. The resulting selected courses may then be used to train an updated course-specific model, which may then be used by the grade prediction generator 126 to generate a grade prediction for a course grade at the end of the 20th (final) class session.

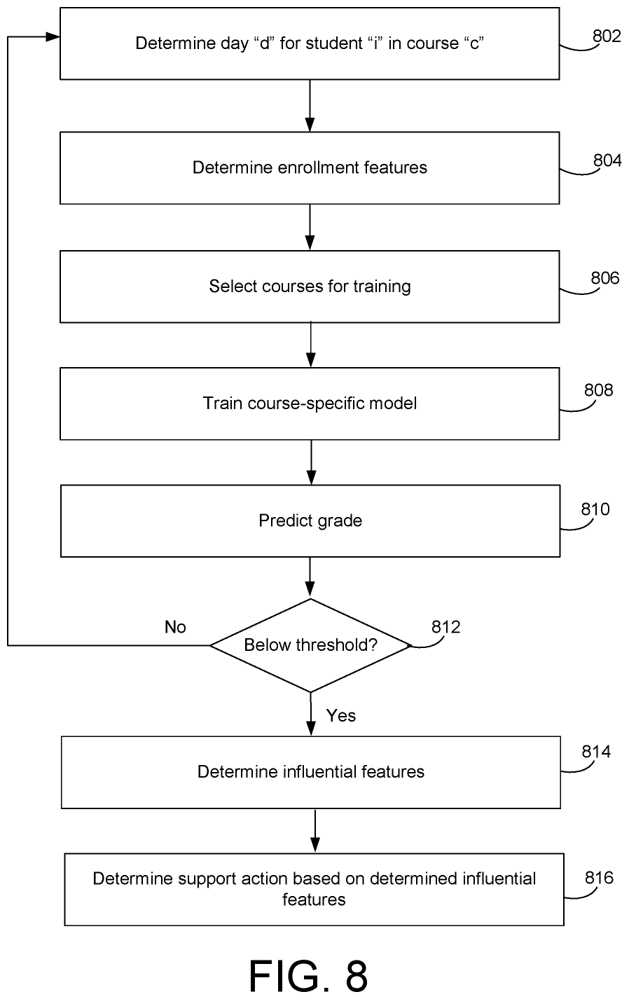

This process may be repeated for each class session, or as desired. At any time that the predicted grade falls below a threshold, or when another trigger is detected, the support recommendation generator 128 may automatically generate a support recommendation, as described herein. This iterative process of continuously predicting a target variable (e.g., the final course grade) is described in more detail, below, e.g., with respect to FIG. 8.

In additional or alternative examples, the course-specific model store 124 may store many pre-trained models. In such implementations, the grade prediction generator 126 may be configured to select (and possibly calibrate or otherwise update) a most-relevant model whenever a grade prediction is to be generated.

In FIG. 1, the student support manager 102 is illustrated as being implemented using at least one computing device 142, including at least one processor 144 and a non-transitory computer-readable storage medium 146. That is, the non-transitory computer-readable storage medium 146 may store instructions that, when executed by the at least one processor 144, cause the at least one computing device 142 to provide the functionalities of the student support manager 102, and related functionalities.

For example, the at least one computing device 142 may represent one or more servers. For example, the at least one computing device 142 may be implemented as two or more servers in communications with one another over a network. Accordingly, the student support manager 102, as well as the various other components of the at least one computing device 142, may be implemented using separate devices, in communication with one another. In particular, the course platform 106 and/or the degree partner 108 may be configured to implement any or all of the various components of the at least one computing device 142. In other implementations, the various components of the at least one computing device 142 may be implemented partially or completely separately from the course platform 106 and/or the degree partner 108, e.g., may be provided as a service thereto.

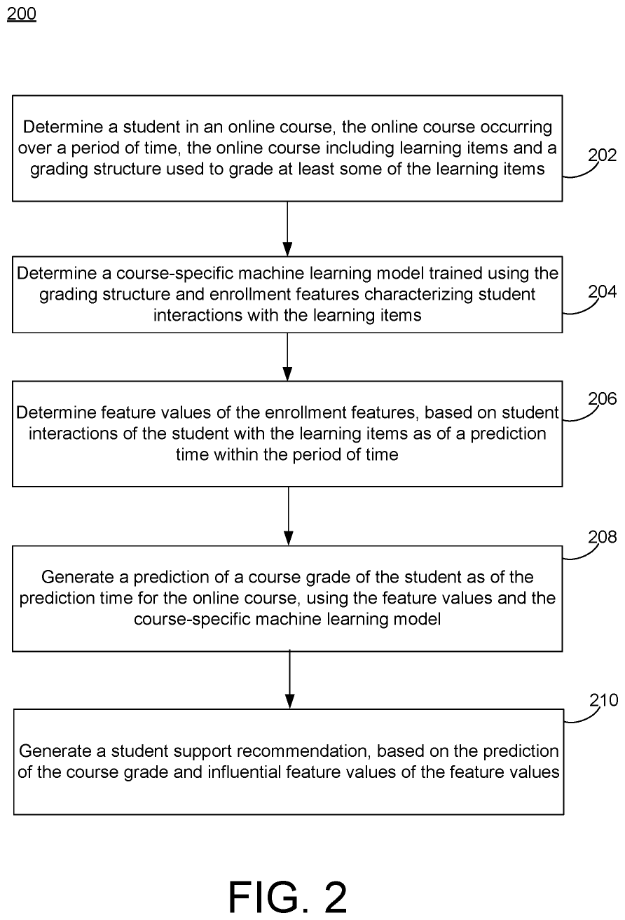

FIG. 2 is a flowchart illustrating example operations of the system of FIG. 1. In the example of FIG. 2, operations 202-208 are illustrated as separate, sequential operations. In various implementations, the operations 202-208 may include sub-operations, may be performed in a different order, may include alternative or additional operations, or may omit one or more operations. Further, in all such implementations, included operations may be performed in an iterative, looped, nested, or branched fashion.

In the example of FIG. 2, a student in an online course may be determined, the online course occurring over a period of time, and the online course including learning items and a grading structure used to grade at least some of the learning items (202). For example, as described, the course data 114 for an online course may include the learning items 116 and the grading structure 118, and the course may be administered to enrolled students of the students 104 over a define period of time. For example, the period of time may include an academic semester or year, or a defined number of days or weeks. In other examples, the period of time may be determined based on a time needed or taken to complete a defined number of classes or sessions included in the online course.

A course-specific machine learning model, trained using the grading structure and enrollment features characterizing student interactions with the learning items, may be determined (204). For example, the grade prediction generator 126 may utilize a course-specific model for the online course from the course-specific model store 124. The training engine 130 may be configured to train (or may already have trained) the course-specific model, using enrollment features in the feature set 134 as selected by the feature selector 132. As also described, the training engine 130 may conduct the training using training data obtained from similar courses, as determined by the course selector 136 using the comparison model 138 and the historical course data 140.

Feature values of the enrollment features may be determined, based on student interactions of the student with the learning items as of a prediction time within the period of time (206). For example, the prediction time may be as of a certain or current class/session, or as of a current day. Thus, the feature values may be considered to be stateful, or to have a condition or status that is dependent upon a time at which that condition/status is determined. For example, a student's current level of activity (e.g., participation) in a course may have a value at a first time, but may be different at a second, subsequent time. Such stateful enrollment features, and associated feature values, reflect interactions of each student with the learning items 116, and may be determined from the interaction log 112 (or storage location derived therefrom), as populated by the interaction monitor 110.

A prediction of a course grade of the student as of the prediction time for the online course may be generated, using the feature values and the course-specific machine learning model (208). For example, the grade prediction generator 126 may be configured to generate the grade prediction of a final course grade. The grade prediction may be shared with the student, and/or with a teacher or administrators. Grade predictions for an entire class of students may be aggregated to judge the student relative thereto, and to assess progress of the class as a whole. In some cases, the prediction time may occur at a beginning of the course for which a grade is being predicted, or prior to commencement of the course. For example, such early predictions may assist in preparing students to take a course, or to select a course to take.

In some implementations, the prediction of the course grade may include a specific grade value or letter grade. In other examples, the prediction of the course grade may include a prediction that a final course grade will be below a threshold, or a prediction of some other at-risk status, without necessarily designating a specific grade value that is predicted.

A student support recommendation may be generated, based on the prediction of the course grade and influential feature values of the feature values (210). For example, the support recommendation generator 128 may be configured to determine that the predicted grade is below a threshold. The support recommendation generator 128 may determine one or more feature values which has the largest impact on the grade prediction, and may generate a corresponding student support recommendation to improve those feature values for the student in question.

Thus, as described above, and as set forth with additional example details, below, online degree programs generally reach larger and more diverse cohorts of students than traditional on-campus programs, face a challenge to effectively scale student support, including high-touch behavioral and academic interventions for struggling students. In order to make student support more efficient and effective, described techniques provide a machine learning solution to a) identify which students are most in need of support and b) provide evidence for the type of intervention that is likely to be most effective.

In example implementations, this task is accomplished by creating frequently (e.g., daily) updated estimations of a student's final grade in each course of enrollment, using the techniques described above, and potentially including the more detailed examples provided below, with respect to FIGS. 3-12. The described grade prediction techniques handle a wide range of different course structures, are applicable to courses that have never been offered before, and tie directly to human-interpretable insights. To meet these properties, the course-specific models referenced herein may be trained with features mined from student actions and training sets dynamically identified to be representative, even for never-before-offered courses.

Features may be identified that are most influential in each individual grade prediction, so that automated, human-readable insights may be generated to accompany the grade predictions. The described approaches allow student support staff to efficiently assist the students most in need of their services, so that a course provider can deliver high-quality, low-cost degree programs to a large number of students.

In particular, online education platforms, such as represented by the course platform 106 of FIG. 1, can host both open courses and fully-accredited degree programs (e.g., in conjunction with the degree partner 108 of FIG. 1) for students around the world. As just referenced, as the number of programs and the size of cohorts continue to increase, it becomes increasingly challenging for humans to support all of the high-touch needs of their students. In particular, one of the most difficult operations to scale effectively is student support: providing academic aid, behavioral intervention, and counseling to students who may be struggling. This type of support traditionally benefits from a personal human touch, and like their in-person counterparts, online programs may maintain a staff of academic and behavioral counselors to ensure their students are well-supported. However, online degrees present a significant challenge to these support teams because they are not staffed to support cohorts of thousands of students. In order to maintain satisfactory support at scale, described techniques enable student support to become more efficient.

In conjunction with FIGS. 3-12, below, more detailed examples of a machine learning solution for increasing support staff efficiency are described. For example, described techniques address at least the following two problems faced by providers of the course platform 106, and/or by the degree partner 108.

First, student support teams are assisted in identifying which students are most in need of help at any given time. This allows the student support teams to focus their attention on learners most likely to benefit, rather than wasting time and energy on students who are already set up well for success.

For new or modified courses, described techniques solve a challenging cold start problem, in which predictions are made for courses that have little or no existing training data available. Further, described techniques enable teachers and administrators to quickly diagnose what type of support might be needed. In addition to identifying which students may require intervention, the described machine learning solutions are explainable. For example, by serving predictions alongside clear and actionable explanations, student support staff are provided with an ability to act quickly and confidently, with minimal need to investigate each case manually.

As reference above with respect to the interaction monitor 110 and the interaction log 112, one aspect of online education is the automated tracking of highly granular logs of learning activities, including all interactions with learning materials, grades on assignments, and participation in course-related activities. These learning logs can be transformed into a rich set of features that can be used to understand and categorize learners in much more nuanced ways than might be possible in an in-person classroom setting. Described techniques select from such features to implement the machine learning applications provided herein.

Although conventional systems may use such online educational logs for other purposes, such as attempting to predict whether a student will dropout (e.g., become inactive for a period of time) in an open online course (e.g., temporal and non-temporal features have been used to predict dropout in each particular week of an open online course, and hidden markov models (HMIs) have been used on item interactions to predict whether a student will continue or dropout in each time period of an open online course).

In the context of online degree courses, for example, predicting dropout is not particularly useful because students rarely dropout, due to higher enrollment costs and academic repercussions for poor performance. Moreover, existing techniques for predicting dropout do not predict a student's course grade, are unable to provide predictions for newly-offered or recently modified courses, and/or do not take a specific grading structure of a course into account. It is very useful to predict the final grade of students as a measure of the health of the enrollment, and described techniques enable, for example, the use of student logs to predict the final grade of degree students without requiring substantial course-specific training data.

For predicting performance of degree students, conventional techniques may use student-specific data sources rather than in-course activity, for example, using demographic variables and past term grades to predict who might be likely to dropout in degree programs. However, these approaches fail to provide insights for student support staff that are actionable within the context of a course (e.g. providing course-specific behavioral suggestions or access to academic tutoring).

Thus, described techniques provide prediction for a continuous target variable (e.g., final course grades), interpretable/course specific predictions (explainability of grade predictions), and generalize to new courses and students (also referred to as a cold start problem).

FIG. 3 is a flowchart illustrating example operations of a feature selection process for training course-specific machine learning models of the system of FIG. 1. As referenced above, and described in detail, below, described techniques may use enrollment features, among other features, to construct course-specific models for predicting course grades for students. In the present description, including FIG. 3, such feature selection may include determination of relative importance levels of various features, as used during model training and construction.

That is, as described with respect to FIG. 1, course data 114 refers to the fact that each student enrollment is affiliated with a particular course, which is comprised of a set of learning items 116 that may be either ungraded or graded. For example, ungraded items may be optional items that typically introduce material (lectures, readings) or allow students to practice the material they have learned (discussion prompts, practice assignments, practice programming notebooks). Graded items may include nonoptional items that impact a student's grade, such as exams, programming assignments, staff-graded essays, or any other wide array of assessment or project available on the course platform.

A student earns scores on graded items that add up to his or her course grade according to a highly customizable grading formula, include in the grading structure 118, which, e.g., assigns a weight to each graded item in the course. Graded items also typically have specific deadlines in each term, which are potentially accompanied by late penalties. Course-level specifications may be used in feature engineering, and, as described in detail below with respect to FIGS. 4-7, in assessing a level of similarity between various courses.

Student-level data, represented in FIG. 1 as student data 120, ma include demographic information about each student and data about the student's past performance in the program. Data about the past performance of students within the degree program, for example, may be helpful in identifying at-risk students early in an enrollment.

In addition to data about the course structure itself, enrollment-specific data represented by the enrollment data 122 of FIG. 1 may be used to predict a student's eventual or final grade in a course. For example, the interaction log 112 of all student-learning item interactions (both ungraded and graded) provides data characterizing an extent to which each student is active and on-track with respect to all courses of that student. The interaction log 112 also provides a full log of each student's submissions and grades for all graded assignments, so that it is possible to understand both activity and performance patterns. This data helps enable the predicting of a student's final grade and generation of actionable insights associated with a prediction.

In the present description, feature engineering or feature selection refers to the identification and use of specific types or categories of data from the course data 114, student data 120, and/or enrollment data 122. Selected features are predictive of how well a student will perform on graded items that are not yet due, and are predictive of how particular behaviors will correlate with corresponding course grades. In addition, as discussed above, features may be selected to ensure that a resulting model leverages interpretable features that lead to actionable insights regarding why a student might have a low predicted grade, and what actions may be taken at the present time to improve the predicted grade, and to ultimately improve the actual, resulting course grade that the student receives.

In the examples described herein, feature engineering processes focus on enrollment-level data, because, for example, course data and student data may be relatively more difficult to act upon in a timely manner. The selected enrollment features are stateful, e.g., may generally be calculated as of any day of the term, and can be updated daily to inform new predictions and insights. In this regard, it will be appreciated that the terms ‘day’ or ‘daily’ are used to indicate stateful and periodic updates to enrollment data, partly for ease of explanation, and because many implementations of the interaction monitor 110 and the interaction log 112 may update on a daily basis. However, it will be appreciated that updates may occur on any desired schedule, with any desired frequency, and/or in response to any specific event that may occur in the context of a particular course (e.g., following each class session, or following specified events or types of events that may occur).

In the example of FIG. 3, feature engineering or selection may include selection of activity features (302). For example, using the interaction log 112 of student-item interactions, multiple activity features that approximate the cumulative and recent activity of a student within a course may be determined. For example, activity features may be determined from the time that students spend on the course platform 106, the consistency of students' activity over weeks of a course, and their level of time investment during each visit. For example, at least the following activity features may be calculated. As may be observed, some of the activity features are cumulative, wile others are limited to a most recent week, e.g., to capture a student's recent momentum or trajectory.

For example, activity features may include active days, representing the number of unique days that student i completed at least one item in course c up until day d. Activity features may include active days last week, representing the number of unique days that student i completed at least one item in course c in the 7 days prior to day d. Activity features may include days since last activity, representing the number of days between the most recent active day and day d (with a default to the number of days since the term started, if the student has been inactive). Activity features may include learning minutes, representing an estimated total number of minutes student i spent actively learning in course c up until day d. Activity features may include learning minutes last week, representing the estimated total number of minutes student i spent actively learning in course c in the 7 days prior to day d. Activity features may include average learning session minutes, representing the average number of minutes that student i spent learning before taking a break in course c up until day d.

In further examples, feature selection may include selecting progress features (304), which may relate to progress towards completions of learning items. For example, item completion may vary by the type of item. For graded items, “completing” may mean submitting and achieving a passing grade. For ungraded items, “completing” may mean reaching the end of the material (e.g. watch the last few seconds of a lecture video). Using item completion events and the grading formula of the course, it is possible to calculate the following example progress features on any given day of an enrollment.

For example, progress features may include ungraded items completed, referring to the number of ungraded items that student i completed in course c up until day d. Progress features may include ungraded items completed last week, referring to the number of ungraded items that student i completed in course c in the 7 days prior to day d. Progress features may include graded items completed, referring to the number of graded items that student i completed in course c up until day d. Progress features may include graded items completed last week, referring to the number of graded items that student i completed in course c in the 7 days prior to day d. Progress features may include graded points completed, referring to the proportion of graded items that student i completed in course c up until day d, weighted by the item's contribution to the course's grading formula.

In further examples, feature selection may include selecting performance features (306), e.g., the performance of students on the graded items completed. For example, using a log of graded item submissions and the final grades achieved, it is possible to construct the following features that represent how well a student has performed on the graded items submitted, and for which they have received a grade.

For example, performance features may include average graded item attempts, referring to the average number of attempts that student i required to pass the graded items in course c up until day d. For example, performance features may include an average item grade, referring to the average grade that student i earned on completed graded items in course c up until day d. For example, performance features may include % of graded points earned, referring to the proportion of possible points (e.g., graded points completed), that student i earned in course c up until day d. For example, performance features may include average grade in previous enrollments, referring to the average grade of student i in previously completed courses in a program.

In further examples, feature selection may include selecting timeliness features (308). For example, using deadlines created by a course designer, it is possible to measure a student's progress relative to the schedule of the course. Timeliness features assist in framing the relative progress of students with respect to the progress recommended by the course designer and provides quantification of how much time is remaining in the course. Using deadlines data in conjunction with student activity logs, it is possible to construct the following features.

For example, timeliness features may include % points submitted on-time, referring to the proportion of graded items that student i submitted o-time in course c up until day d, weighted by the item's contribution to the course's grading formula. For example, timeliness features may include net ungraded items completed, referring to the difference between ungraded items completed and the number of ungraded items that have been due in course c prior to day d. For example, timeliness features may include net graded items completed, referring to the difference between graded items completed and the number of graded items that have been due in course c prior to day d. For example, timeliness features may include net graded points completed, referring to the difference between graded points completed and the number of graded points that have been due in course c prior to day d.

FIG. 4 is a flowchart illustrating example operations of a course selection process for training course-specific machine learning models of the system of FIG. 1. That is, FIG. 4 provides example implementations of the course select 136 and the comparison model 138 of FIG. 1.

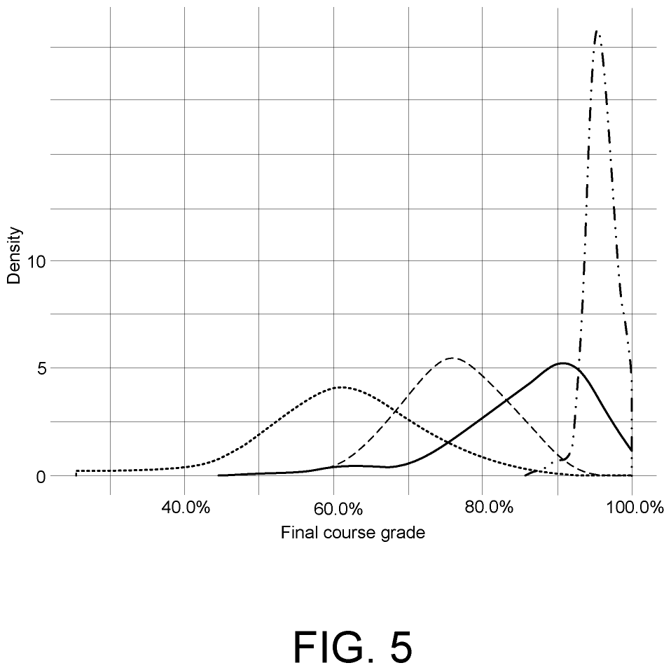

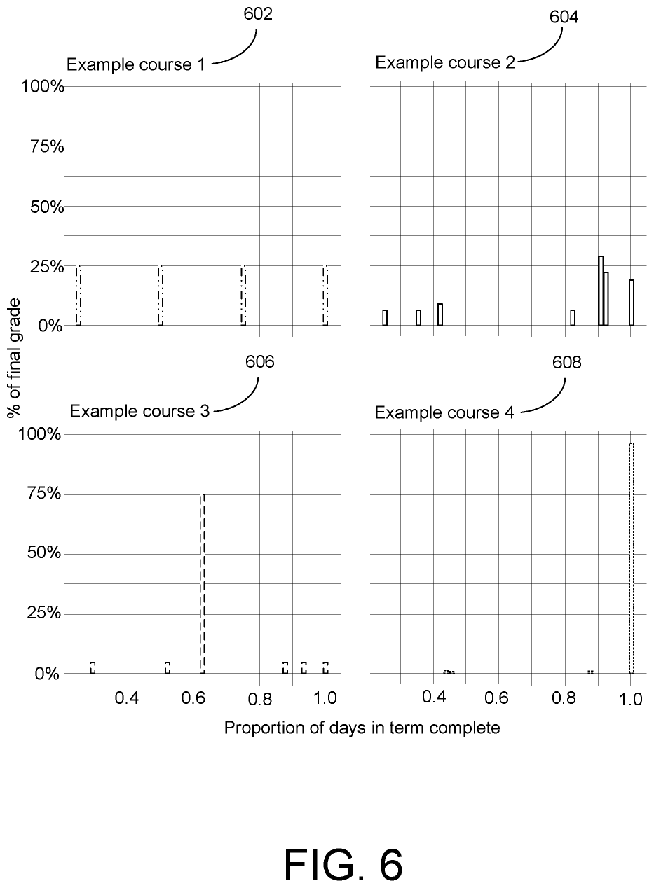

As referenced above, when sufficient training data is not available (referred to herein as the cold-start problem), described techniques are still able to make reliable predictions, including for a new course with no historical enrollments. For example, when a course is offered for the first time, it is possible to use data from other courses to train a course-specific model for estimating future grades. However, identifying suitable, representative training data from historical courses is difficult, e.g., because there is typically great variance in content, structure, and the distribution of grades (as illustrated and described, for example, with respect to FIGS. 5 and 6).

Thus, in order to inform an at-risk status of enrolled students, stored interaction data from historical courses that ran in the past (e.g., historical course data 140 in FIG. 1), across different programs in both technical and non-technical domains, may be used. Among all of these programs, a large quantity of past course enrollments (e.g., tens or hundreds of thousands) can serve as the training set to predict whether a future student might be at risk of receiving a poor grade.

In order to evaluate the effectiveness of resulting course-specific models, a most recent completed term (e.g., Fall 2019) may be used as a validation set for a current term (e.g., Spring 2020). For example, Fall 2019 may include over 21,000 course enrollments across 83 courses in 11 unique degrees, and 20% of these enrollments may be in courses that are running on the platform for the first time (thus a “coldstart”). This data may be used as a validation set enables benchmarking of the accuracy of the corresponding course-specific model, as well as the tuning of hyperparameters, and the selecting of course-specific models in a scenario that most closely resembles the task of making accurate predictions and inferences in the current term (e.g., Spring 2020).

Put another way, in order to produce accurate grade predictions, the course-specific model being trained should use a representative sample of past enrollments on appropriate days of the term (when grade predictions are to be made on a daily basis). Courses in a training set most representative of each course in the validation set may be selected.

For example, in FIG. 4, suitable courses and associated training data may be selected by first selecting suitable course comparison parameters to use (402). For example, in the examples of FIGS. 5-7, below, course comparison parameters may include, or characterize, student grade distributions. For example, student grade distributions may be compared using selected summary statistics, such as a sample average and a sample standard deviation.

By definition of the cold start problem, in which a new or modified course is being offered for which insufficient training data exists, the new or modified course does not have sufficient data that is existing and available for comparison using the selected course comparison parameters. Instead, described techniques predict the necessary course comparison data to use. However, in contrast to the course-specific models used for grade prediction, the comparison model 138 of FIG. 1 may be generated and trained using course-level features, which are available at a start of a course and before enrollment data is available.

For example, course-level features regarding course structure and continuous student performance may be selected (404). Then, the comparison model 138 may be constructed (406) to execute the comparison of the selected course comparison parameters. Again, specific examples are provided below, with grade distribution providing the basis for course-level features, with respect to FIGS. 5-7.

Then, various different courses may be considered as of the relevant day or date of prediction (408). The actual and predicted values of the comparison parameters may be used to quantify similarities of courses (410). As already referenced, both training and comparison are performed as of a specific day or other temporal marker within both the course being evaluated and the courses selected for training purposes. In this way, selected courses may be provided for training (412), as referenced above and described in more detail below with respect to FIG. 8.

FIGS. 5-7 illustrate example data and results for an implementation of the course selection process of FIG. 4. As referenced, one example way to determine how representative one course is of another is to measure how similar the courses are in their distributions of student grades on the future items of the course, referred to as ĝ_{F}. That is, grades on future items refers only to a component of a final or course grade that is determined by graded learning items for which grades have not yet been completed or assigned. As described in example implementations below, the final or course grade may include additional grade components, such as grades already completed and assigned, or overdue graded items for which a submission deadline has passed but for which partial credit may be obtained in response to a late submission.

For courses in an existing training set (e.g., in the historical course data 140), the distribution of ĝ_{F} may be observed directly. Grade distributions tend to be roughly normal, as shown in FIG. 5, so that it is possible to summarize such distributions numerically with summary statistics, such as the sample average and sample standard deviation.

As described with respect to FIG. 4, in order to compare these distributions to those of courses in a validation and test set, future grade distributions are forecast. To accomplish this, linear models, represented by the comparison model 138, may be used that enable estimation of the mean (\hat{μ}_{c,d}.) and standard deviation (\hat{σ}_{c,d}.) of the grade distribution on future items on any day of the term d.

In order to predict these values, course-level features may be used that provide information about the course structure, the progress of the course, and the performance of students up until day d. The features that are used in the model may include, e.g., a program identifier (e.g., one-hot encoded dummy variables identifying the degree program to which course c belongs), an at risk threshold (threshold for determining if a student is at risk, which may be chosen by each degree program), and days since course start (number of days between the start of course c and day d). Other examples may include days until last deadline (number of days remaining in course c from day d to the final deadline in the course), graded points due (proportion of the total graded items due in course c prior to day d, weighted by the item's contribution to the course's grading formula), and average % of graded points earned (average proportion of possible points that students earned in course c up until day d).

For example, FIG. 6 illustrates course structures of sample courses from four different programs. As may be observed, some courses (e.g. Example course 1 (602)) have evenly distributed graded items throughout a course. Example course 2 (604) has graded items occurring more frequently, and with more impact, at an end of the course. Example course 3 (606) has graded items occurring more frequently at an end of a term, but with a high-impact mid-term grade. Example course 4 (608) has graded items that are heavily weighted toward a single, final grade at the end of the term. Thus, FIG. 6 illustrates that to make reliable daily grade estimations, representative training set for each course on each day of the term should be identified.

Continuing the example above, the selected training set of courses may be used to fit a linear model using ordinary least squares, and thereby estimate the average and standard deviation of ĝ_{F} for each course in the validation set on each day of the term. On the validation set, the model is able to predict \hat{μ}_{c,d} with a mean absolute error (MAE) of 0.028 and predict \hat{σ}_{c,d} with a MAE of 0.031.

Using the predictions of \hat{μ}c,d and \hat{σ}_{c,d}, each course in the validation and test sets may be compared to courses in the training set, in which it is possible to directly observe the average and standard deviation of the distribution of ĝ_{F}. For each course and date in the validation set, the date in each potential training course that is most aligned with the date in the validation course may be selected. For example, the date in each training course may be selected that is most similar in terms of number of graded points due, and if multiple such dates exist, then the date that is most similar in terms of days until last deadline.

Once one comparison date in each potential training course is available, it is possible to find the training courses with an observed average and standard deviation of ĝ_{F} that are most similar to the predicted \hat{μ}_{c,d} and \hat{σ}_{c,d} for the validation course and date of interest. After normalizing both the average and standard deviation (so that they have similar scales), Euclidean distance may be used to identify the courses in the training set that are most representative of the course in the validation set. For the final training set, the most similar courses may be selected that together provide at least 1,000 training enrollments to be used to train a course-specific model for estimating future grades.

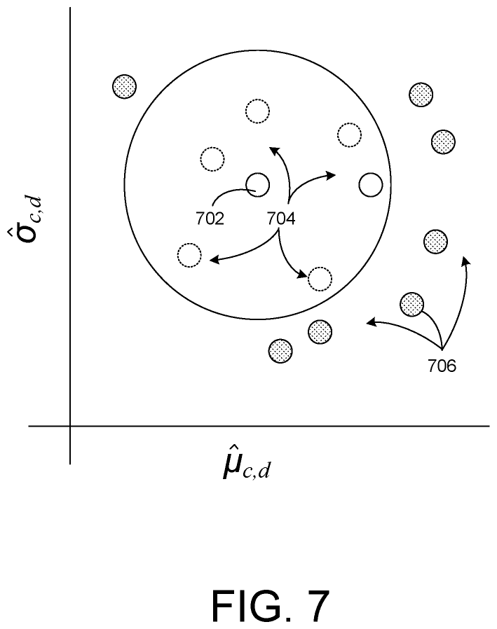

This process is illustrated in FIG. 7, in which a course 702 for which grade predictions are desired is compared to various other courses 704, 706. As shown, the courses 704 represent courses sufficiently similar to the course 702 to be selected for training (in terms of, e.g., observed mean and standard deviation of grades chosen for courses 704 to best match estimated values from the validation and test data with respect to the course 702), while remaining courses 706 are non-selected. This approach may be replicated for the test set by using both the training and validation sets as sources for potentially representative courses.

Then, following course selection, and for each course and date in the validation and test sets, a specific set of the training enrollments that are most representative of the course in question are available. Using these training sets, it is possible to fit separate models for all courses c on all days of the term d. The following description provides examples of how these models are fit and then utilized to make estimates for all of the enrollments in the validation and test sets.

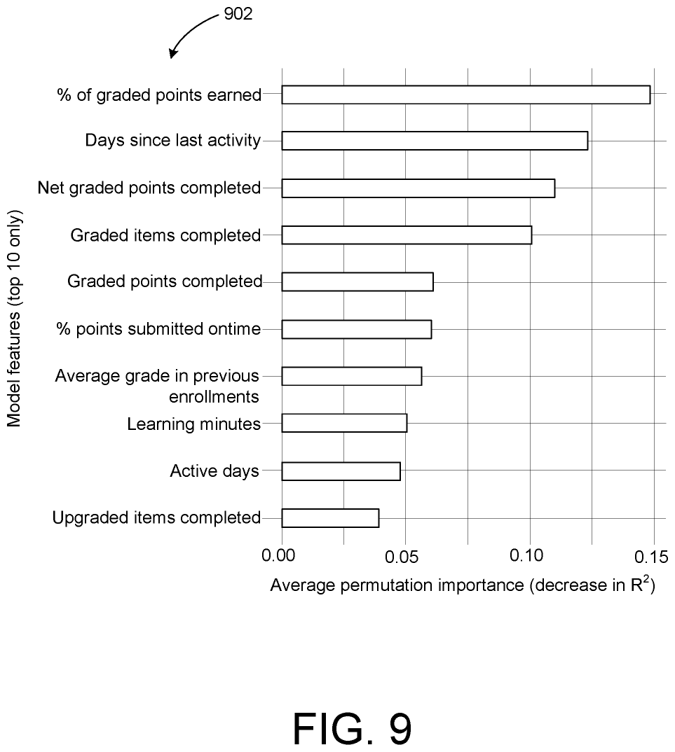

For example, in some implementations, random forest models may be used for this prediction task. In addition to their prediction performance, random forest models are able to account for many input features and account for nonlinear interactions. Their tree-based components also ensure that grade estimates remain in the natural range of proportions [0,1]. In addition, random forest models have natural methods for assessing permutation importance of each feature, which is useful for highlighting the reasons behind the predictions, as described in detail below with respect to FIGS. 8 and 9.

As random forest models may be susceptible to changes in hyperparameters, grid search on 3-fold cross validation may be used to select the best hyperparameters for each course and day-specific model. That is, specific hyperparameters may be tuned, with values that are iterated over in a grid search. For example, a ‘maximum depth’ parameter may be used with grid values 3, 5, 7, none that are iterated over in the grid search, a ‘maximum features’ parameter may be used with grid values 5, 9, 13, none that are iterated over in the grid search, and a ‘number of trees’ parameter may be used with grid values 500, 1000 that are iterated over in the grid search.

Using models trained with the optimal set of hyperparameters, the average prediction from all the trees in each forest may be used to estimate the future grade ĝ_{F}. In addition, the variability in the ensemble of trees may be leveraged to produce an upper-bound and lower-bound estimate, e.g., using the 10ₜₕ and 90ₜₕ percentiles of the estimators, respectively. Using these estimates, a predicted final grade may be calculated, as well as an upper and lower bound for the prediction. All of these can be directly served to student support staff to help them quickly identify which learners are struggling based on simple and easily understandable criteria.

FIG. 8 is a flowchart illustrating more detailed examples of daily operations of the system of FIG. 1. That is, in FIG. 8, for example, enrollment data may be updated daily, in which case grade predictions may be updated at most daily.

In FIG. 8, a day d for student i in course c is determined (802). For example, a current or most-recent day may be selected, and the process of FIG. 8 may be repeated for each student and each course.

Enrollment features may be determined (804) for the course in question. For example, the process of FIG. 3 may be implemented. In some cases, the same set of enrollment features may be used from day to day, while in other cases, selected enrollment features may be changed/updated each day that the process of FIG. 8 is executed. Other types of features, such as course features or student features, may additionally or alternatively be used.

Courses for training may be selected (806). For example, the processes of FIGS. 4-7 may be implemented to select a sufficient number of courses and enrollments, sufficiently similar to the course c in question, to use for training purposes.

Then, the course-specific model for the course c in question may be trained (808), using the selected courses and associated training data. In this way, a course grade for the student i may be predicted (810), using the course-specific model.

If the resulting, predicted grade is not below a pre-determined threshold (812), then the process may continue (802), as shown. If the predicted grade is below the threshold (812), then a subset of the selected enrollment features used to construct the course-specific model may be identified as being particularly instrumental or important in operations of the course-specific model in predicting the course grade (814). Examples of a process and result for identifying such instrumental features are referenced above, and provided in more detail below, with respect to FIG. 9.

Finally in FIG. 8, a support action or recommendation may be determined based on the influential features (816). For example, student support staff may receive a notification for each such student, and information regarding areas of need for the student.

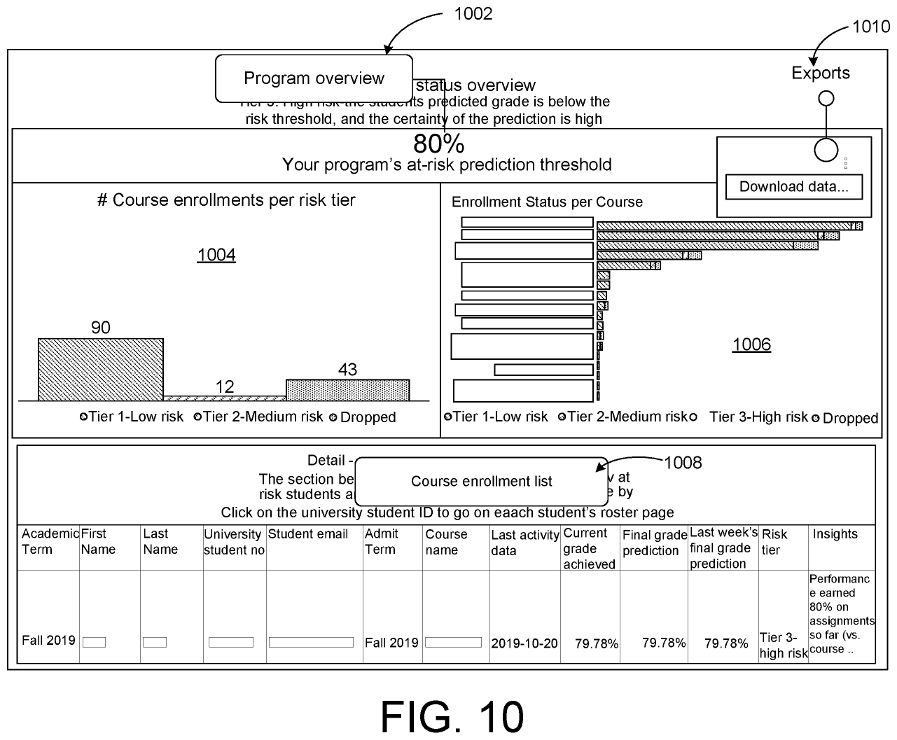

In addition to informing student support staff actions, grade predictions and insights may also be used to power an automated weekly email that provides actionable suggestions for students who are flagged as “Tier 2” or “Tier 3” of risk (where examples of risk tiers are illustrated in FIG. 10). These emails may be personalized to students based on the features in the model that are most responsible for their grade prediction. For example, if a student has been inactive the previous 7 days, the email template urges them to participate in their course consistently. This email allows the provider of the course platform 106 to take early action on at-risk students to complement higher-touch interventions by student support staff.

FIG. 9 is a graph illustrating a feature selection process for identifying areas of student support based on operations of a course-specific machine learning model in predicting a student's course grade. Specifically, the graph of FIG. 9 illustrates a plurality of model features 902 graphed against average permutation importance, to distinguish relative levels of influence of each of the model features 902 in predicting a corresponding course grade for a student.

For example, permutation importance generally refers to an example of a measure of importance of each feature in a course-specific model, which may be determined as a decrease in a model score in response to a random shuffling of a feature being tested. For example, for a regression-based model, R² refers to a score indicating a statistical measure of how close data are to a fitted regression line. FIG. 9 illustrates, for a feature of the features 902, an extent to which R² decreases (e.g., on average, over multiple validation models, including course and date-specific models) when that feature is randomly shuffled and R² is re-computed.

Although course-specific models may have many features, FIG. 9 illustrates that a set of top 10 most influential features may be identified, shown in FIG. 9 as % of graded points earned, days since last activity, net graded points completed, graded items completed, graded points completed, % points submitted ontime, average grade in previous enrollments, learning minutes, active days, and ungraded items completed. As also shown, the graph of FIG. 9 illustrates the relative levels of average permutation importance of each of these features, thus providing specific areas of a course in which a student might best benefit from staff support in a way that is standardized and not fragmented.

In addition to average permutation importance, qualitative research, conducted with student support staff from all existing degree programs, may be incorporated. In this way, it is possible to understand which candidate features are most easily understood and actionable in driving within-course interventions. With this additional input from existing support staff, a final subset of features that are both highly influential in our models and resonate strongly with the users of the models' outputs may be identified. For example, such a feature set may include: 1) % of graded points earned, 2) learning minutes, 3) net graded points completed, 4) days since last activity, and 5) % points submitted ontime.

Using this subset of features that are most influential on average, it is then possible to select which are most important for each individual prediction. For example, for each of the five key features identified above, enrollments may be identified in which the value of the feature is below the median for the course as a whole. To understand whether this feature significantly impacts the final model prediction, its value may then be permuted to the median. If this transformation significantly impacts the predicted course grade (e.g., by at least 3%), then a prediction insight may be associated with this enrollment, providing a human-readable explanation of the feature's value and its importance.

Student support staffers may then directly use these insights to determine which intervention might be most beneficial to a struggling student. For example, students with low predicted grades who have low learning minutes might benefit from a behavioral intervention urging them to spend more time on their material. On the other hand, students who have been sufficiently active but have performed poorly on graded items (low % of graded points earned), might require some academic support from a teaching assistant or tutor.

Additional examples of types of insight that might be provided to support staffers include performance insights (e.g., student earned 70% on assignments so far, vs. 88% for course median), attendance insights (e.g., 2 hours spent learning, vs. course median of 6 hours), progress insights (e.g., 3 assignments overdue, accounting for 15% of course grade), recent item completion (e.g., 8 days since last item completion, vs. course median of 2 days), and late submissions insights (e.g., 25% of items submitted past due, vs. course median of 0%).

FIG. 10 is an example screenshot of a graphical user interface that may be used in the system of FIG. 1, e.g., a student success dashboard. Such a student success dashboard may be provided with the generated grade predictions, and may be viewable by support staff for each course, to enable the support staff to effectively interpret and act upon the predictions and insights generated by the system of FIG. 1.

As shown, the dashboard provides an overview 1002 of the expected performance of all students in the course, including the course's at-risk prediction threshold (e.g., 80%). The dashboard may include a section 1004 that illustrates a number of enrolled students in each of three Risk Tiers, as referenced above. For example, Tier 1 may be identified as a low-risk student, Tier 2 as medium risk, and Tier 3 as high risk, with an additional identifier for students who have dropped the course.

The dashboard further includes a section 1006 that identifies an over view of enrollment status per course. As shown, the section 1006 enables illustration of each of a number of specific courses, each with an illustration of number/percentage of students in each risk tier, or dropped out.

Section 1008 provides a detailed table that identifies each student, along with the predictions and insights for that student from a corresponding course-specific model. As shown, the table may identify the student, along with an identification of the relevant course, last activity date, current grade, predicted final grade, a final grade prediction from a preceding week, a risk tier, and associated insights for supporting the student. Thus, for example, it is possible to utilize not just a current grade prediction, but preceding grade predictions, in order to establish and utilize a trend in predicted grades that may be indicative of a student's progress or needs.

In addition to personal identifying information about each student (only available to permissioned staff), the table in section 1008 includes the most recent predicted grade and insights that highlight which features in the model are responsible for a low grade prediction. The student's predicted grade is translated into a corresponding “at-risk tier” based on grade thresholds of risk, e.g., that each course selects independently.

For example, if a student's predicted grade is above the program-specific at-risk threshold, then they are deemed “Tier 1”, and likely do not require any additional monitoring or intervention. If a student's predicted grade is below this threshold, however, then the student is listed in a higher tier of risk. “Tier 2” students are expected to achieve a grade below the threshold, but the upper bound of their grade prediction is still above the threshold. These students are likely to require intervention to get back on track, and the prediction insights affiliated with these enrollments can be used to inform which intervention should be taken. Students are categorized as “Tier 3” if even their upper bound grade prediction is below the grade threshold. These students are very unlikely to achieve a grade above the risk threshold on their current track, and the prediction insights can provide additional explanations of why the student is doing so poorly.

Many other aspects may be included in the dashboard of FIG. 10. For example, an exports option 1010 may be provided to enable support staff to utilize provided data in other contexts.

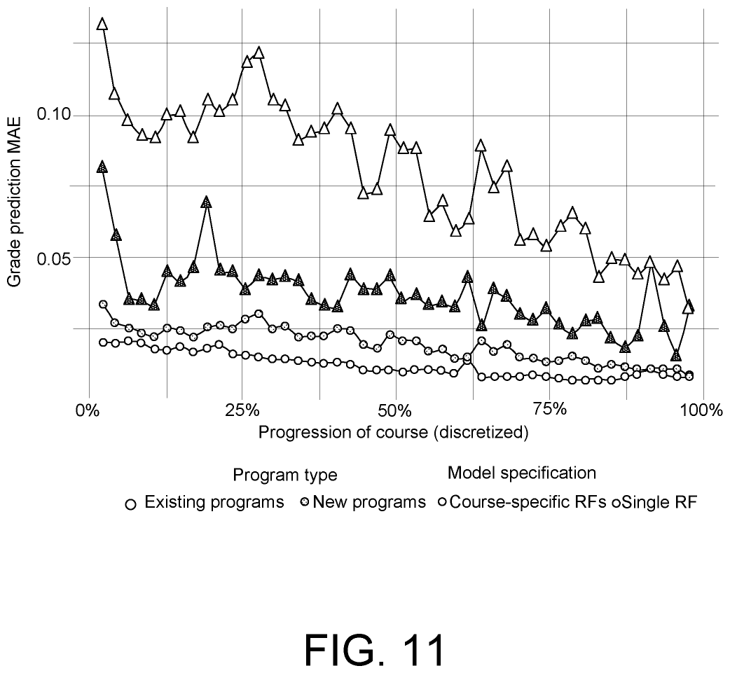

FIG. 11 is a graph illustrating a progression of grade predictions in conjunction with progression of a related course. Specifically, using implementations of the methodology outlined in previous sections, it is possible to achieve reliable grade prediction accuracy for a wide variety of courses from the start of the course until the end of the term. Using a validation set (e.g., courses offered in a recent term, such as Fall 2019), it is possible to quantify the performance of the described approach for different types of courses at different days in the term.

FIG. 11 illustrates the mean absolute error (MAE) of grade prediction for 11 programs in the validation set at a variety of different time points. As a reference, the performance of an alternate approach of training is included, in which a single random forest model with all available training data is applied to all courses in the validation set.

In contrast, described techniques approach leveraging course-specific training sets and models, and performs much better than a single, generalized model, especially for courses in new programs. The MAE on the validation set remains below 0.03 for the vast majority of the grade predictions obtained using the described techniques. Grade predictions become more accurate later in the course (with more information about each student's performance) and later in a program's history (with more relevant training data).

More specifically, in the examples, MAE tends to decrease for predictions made later in the course. In addition, new degree programs tend to have errors slightly higher, but still similar to those of programs with several previous terms worth of training data. When compared to the baseline single random forest, FIG. 11 illustrates that using course-specific training sets leads to much more accurate predictions, especially for new programs. Thus, described approaches for identifying the most representative training sets for each course in the validation set enables successful solution of the cold start problem and provides accurate predictions for brand new programs.

In one implementation, during the Fall 2019 term of courses offered by a course provider, over 4 million daily estimates were made of the final grades that degree students would earn in their courses. In this time, over 3,000 course enrollments were identified where the predicted grade at some point dipped below the “at-risk threshold” referenced above. All 11 degree programs active in the Fall 2019 term received daily-updated visibility into which students were most in need of interventions, with accompanying insights into how those students were identified.

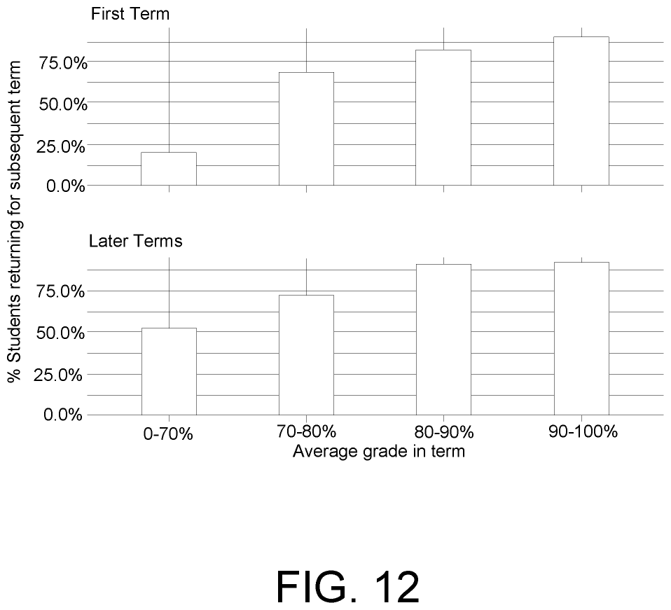

FIG. 12 is a graph illustrating an example correlation between a student's grade and a likelihood of the student returning for a subsequent term. For both a course platform provider and its partners (e.g., universities and course content providers), the ultimate goal of student support is to ensure that students progress towards graduation. Because graduation often takes 2-4 years to measure for most degree programs, it is useful to find a leading indicator that can be predicted more quickly. FIG. 12 demonstrates that a student's likelihood of retaining (e.g., returning in a subsequent term) in a degree program is highly correlated with a student's average grade across their courses in a given term. In fact, grades are a reliable predictor of program retention even after just one academic term.

In addition to surfacing a reliable indicator of whether or not a student will retain in a program, estimating final grades also allows for interventions on the level of an individual course, which enables more effective, timely, and nuanced action. Because a student's status can change quickly in a given enrollment, we must ensure that our grade estimations are up-to-date. Because most enrollment level data updates daily in the course platform provider's data warehouse, as referenced above, creating daily predictions of final grade is a beneficial solution.

Therefore, an example implementation is described below, in which the machine learning problem becomes predicting student i's final grade in course c on all days d from the beginning of the term to the last deadline in the course. In equations below, the final predicted grade as Ĝ_{i,c,d}, or Ĝ.

In this example, in order to make daily estimates of what a student's final grade will be at the end of a course, both the student's grades accumulated to that point in time and predictions about the remainder of the course are incorporated. One of the challenges in estimating future grades is that they are highly dependent on the structure of the course, especially the grading formula. Simply treating the current grade as a feature in the model does not take into account the fact that part of the student's grade is now completely fixed. In addition, just predicting a student's grade on future assignments does not account for the fact that learners may still earn grades on assignments that are past their deadlines. At any given point, all components of a student's grade fall into one of three categories: completed items that have already been completed and have a determined grade, future items that are incomplete and due in the future, and overdue items that are incomplete but past their due date. To account for these complications properly, a student's final predicted grade may be modeled as the sum of these three components, as shown in Equation (1):

Ĝ=(i_{C}·g_{C})+(p_{F}·ĝ_{F})+(p_{O}ĝ_{O}) (1)

where p_{C}, p_{F}, and p_{O} are the proportions of graded points already completed, due in the future, and overdue, respectively. Similarly, g, ĝ_{F}, and ĝ_{O} are the grades that students earned on assignments that have been graded, are due in the future, and are overdue, respectively. At any given point, p_{C}, p_{F}, p_{O} and g_{C} may be observed directly, but ĝ_{F}, and ĝ_{O} must be predicted. These become the target variables in the machine learning problem, each with a separate model, such as described above. Table 1 provides examples of how this grade prediction formula may be implemented, with two example calculations.

TABLE 1

| Symbol | Definition | Ex. 1 | Ex. 2 |
|---|---|---|---|
| p_{G} | proportion of graded points already | 0.5 | 0.1 |
| | completed | | |
| g_{G} | grade on already completed items | 0.6 | 1.0 |
| p_{F} | proportion of graded points due in the | 0.5 | 0.8 |
| | future | | |
| ĝ_{F} | predicted grade on items due in the | 0.8 | 0.7 |
| | future | | |
| p_{O} | proportion of graded points overdue | 0 | 0.1 |
| ĝ_{O} | predicted grade on overdue items | 0 | 0.2 |
| Ĝ | predicted final grade | 0.7 | 0.68 |

In order to estimate the grade that a student will receive on graded items that are overdue (ĝ_{O}), the specific policies enforced for each overdue item in a course should be considered. For example, graded items can either have no penalty for late submissions, a fixed penalty for all late submissions, or an incremental penalty that lowers a grade by a specified amount for each day that an item is overdue.

In addition, the number of days that each item is overdue should be taken into account in order to estimate a student's likely score. Because these variables are observed on an item-by-item basis, ĝ_{O} may be defined as the sum of the predicted grades on all overdue items, rather than modelled directly. To estimate these individual overdue item grades, a linear regression model with simple, item-level features may be used. A more complicated modeling framework may also be used, although overdue items are in general rare and only account for an average of 4.2% of a student's final grade at any particular time during the enrollment.

For each item j that is overdue on day d during a course enrollment (student i in course c), the predicted final grade may be modeled prior to applying late penalties ĝ_{j,i,c,d} as a linear sum, as shown in Equation (2):

$${\hat{g}}_{j , i , c , d} = α + ( {β}_{1} \cdot {D}_{j , d} ) + ( {β}_{2} \cdot {G}_{i , c , d} ) + ( {\vec{p}}_{p} \cdot \vec{Φ} ) + ( {\vec{t}}_{j} \cdot \vec{Ψ} ) \qquad ( 2 )$$

in which variables and model parameters defined as:
D_{j,d}: the number of days that the item is overdue
G_{i,c,d}: the grade of the student in the course as of date d
\vec{p_{c}}: a vector in [symbol] ^{P} with 0 entries except for a single 1 entry at index p denoting the program to which the course belongs, with 1<=p<=P and P the total number of programs
t̅ⱼ̅: a vector in [symbol] ^{T} with all 0 entries except for a single 1 entry at index t denoting the item's type, with 1<=t<=T and T the number of distinct graded item types (e.g. quiz, programming assignment, project, etc.)
α, β₁, β₂, \vec{Φ}∈ [symbol] ^{P}, \vec{Ψ}∈ [symbol] ^{T}: model coefficients estimated using least squares regression on the training set

These features are able to explain the majority of variance in overdue item grades. On top of the model's predictions, an appropriate late penalty (L_{j,d}) may be applied for each item j on day d, and aggregated across all overdue items to reach a final estimate for this portion of a student's grade, as shown in Equation (3):

$${g}_{O} = {\sum }_{j} {L}_{j , d} \cdot {\hat{g}}_{j , i , c , d} \qquad ( 3 )$$

Several metrics of a model's performance on the validation set may be used in estimating a student's grade on each overdue item, as well as a student's final grade on all overdue items after applying penalties. For example, in examples of performances of grade prediction on overdue items in the validation set, individual item grade performance metric values may include 0.0419 for RMSE, 0.0352 for MAE, and 0.748 for R². Overall weighted grades on all overdue items may be obtained with performance metric values of 0.0081 for RMSE, 0.0051 for MAE, and 0.810 for R².

Because late penalties often determine a student's grade on overdue items with some certainty, a very low absolute error in an estimation of go may be observed. With such promising validation accuracy, an identically-specified model trained on the training and validation set may be used to make inferences on a test set of enrollments in a current term, as described in detail above with respect to predicting student grades on items due in the future.

In the preceding examples, components of a final predicted grade are described, with description of how the grade a student will receive on overdue items is estimated. Example techniques for predicting grades on future items are described above in detail with respect to FIGS. 1-9. In particular, at the beginning of an enrollment, all graded items are incomplete and due in the future, so the task of predicting a grade for each item separately would be far more difficult to assess certainty or understand the importance of various features. For that reason, ĝ_{F} may be modeled directly, as described above, rather than predicting each item grade separately, so that a model may be built that is capable of predicting ĝ_{F} for each course enrollment on each day of the term.

Thus, a multi-stage application of machine learning may be used to provide a solution to grade prediction in online degrees. Accurate and interpretable grade estimators may be trained for all courses in all programs, thereby solving the cold start problem for new courses and fulfilling the need for accompanying actionable insights. Using course-specific grade formulas to break the problem into separate predictive tasks, portions of a student's grade that are already determined may be differentiated from the portions that must be predicted. For the most difficult machine learning task of predicting performance on items that are due in the future, a representative training set for each course on each given day may be identified. Then, for example, a specific random forest model may be trained to generate predictions. This approach has enabled grade predictions that accurately inform which students are most in need of support at any given time. Moreover, these predictions are reliable even for new courses in new programs that have never been offered before. Over time, as more program-specific and course-specific data is collected, predictions naturally become more and more accurate.

In addition to creating reliable grade predictions, described techniques also generate human-interpretable insights about each estimate. These insights are key to making the predictions themselves useful, as they enable student support staff to quickly identify what actions should be taken to help a learner who may have a low predicted grade. Allowing student support to target the specific students that are most in need of their help allows these teams to function efficiently at scale. This efficiency enables maintaining the affordability and quality of online degree programs that make them such a great alternative for many students.

Additional data also can be useful for both building additional features for our model and highlighting potential insights for student support staff, including, for example, off-platform learner activities, additional user-level features, and more nuanced activity features. However, to maintain the actionability of described prediction insights, predictions may be provided based on features that are immediately actionable.

Described grade predictions have low errors, and measure and account for the actual interventions that the underlying model(s) inspires. Comprehensive tracking of which students are actually being targeted with interventions, what types of interventions are being used, and how those interventions might influence student performance may be used as inputs to further enhance the model.

An ability to account for intervention effects provides an unbiased impact on an ability to predict final grades effectively. For example, if enrollments that are flagged as requiring support receive interventions that increase their grades, this might reduce an ability to use these enrollments as unbiased training samples in the future. The interventions received may be accounted for in the model itself, or, in other implementations, the target variable (e.g., final grade) may be adjusted so that it might be less impacted by feedback from the model.

Knowing more about the types of interventions being used and their effectiveness may allow us to move past predicting that an enrollment is at-risk and towards recommending specific interventions for each student. This enables further efficiency in student support efforts so that programs on the course platform provider can continue to increase their scale and impact.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
determine a student in an online course, the online course occurring over a period of time, the online course including learning items and a grading structure used to grade at least some of the learning items;
determine a course-specific machine learning model trained using the grading structure and enrollment features characterizing student interactions with the learning items;
determine feature values of the enrollment features, based on student interactions of the student with the learning items as of a prediction time within the period of time; and
generate a prediction of a course grade of the student as of the prediction time for the online course, using the feature values and the course-specific machine learning model.

2. The computer program product of claim 1, wherein the instructions, executed by the at least one computing device, are further configured to cause the at least one computing device to:
determine influential enrollment features on the predicted course grade;
determine influential feature values of the feature values, based on the influential enrollment features; and
generate a student support recommendation, based on the prediction of the course grade, the influential enrollment features, and the influential feature values.

3. The computer program product of claim 2, wherein the influential enrollment features are determined based on a permutation importance of each of the enrollment features in predicting course grades for a validation dataset.

4. The computer program product of claim 1, wherein the instructions, executed by the at least one computing device, are further configured to cause the at least one computing device to:
train an updated course-specific machine learning model following the prediction, and prior to an updated prediction time; and
generate an updated prediction of the course grade as of the updated prediction time, using the updated course-specific machine learning model.

5. The computer program product of claim 4, wherein the instructions, executed by the at least one computing device, are further configured to cause the at least one computing device to:
generate the updated prediction of the course grade using actual enrollment feature values of the student that occurred between the prediction time and the updated prediction time.

6. The computer program product of claim 1, wherein the instructions, executed by the at least one computing device, are further configured to cause the at least one computing device to train the course-specific machine learning model including:
selecting at least one additional course in addition to the online course; and
training the course-specific machine learning model using the selected at least one additional course.

7. The computer program product of claim 6, wherein the instructions, executed by the at least one computing device, are further configured to cause the at least one computing device to train the course-specific machine learning model including:
selecting course comparison parameters for comparing the online course with a plurality of courses, including the at least one additional course;
selecting course-level features of the online course and the plurality of courses;
constructing a comparison model based on the course-level features;
predicting course-level feature values of the course level features for the online course, using the comparison model; and
selecting the at least one additional course, including comparing the predicted course-level feature values and corresponding feature values of the plurality of courses.

8. The computer program product of claim 1, wherein the enrollment features include at least one of activity features, progress features, performance features, and timeliness features.

9. The computer program product of claim 1, wherein the course grade is predicted based on a prediction of a grade that will be received on at least one overdue item following the prediction time.

10. A computer-implemented method, the method comprising:
determining a student in an online course, the online course occurring over a period of time, the online course including learning items and a grading structure used to grade at least some of the learning items;
determining a course-specific machine learning model trained using the grading structure and enrollment features characterizing student interactions with the learning items;
determining feature values of the enrollment features, based on student interactions of the student with the learning items as of a prediction time within the period of time; and
generating a prediction of a course grade of the student as of the prediction time for the online course, using the feature values and the course-specific machine learning model.

11. The method of claim 10, further comprising:
determining influential enrollment features on the predicted course grade;
determining influential feature values of the feature values, based on the influential enrollment features; and
generating a student support recommendation, based on the prediction of the course grade, the influential enrollment features, and the influential feature values.

12. The method of claim 11, comprising:
determining the influential enrollment features based on a permutation importance of each of the enrollment features in predicting course grades for a validation dataset.

13. The method of claim 10, further comprising:
training an updated course-specific machine learning model following the prediction, and prior to an updated prediction time; and
generating an updated prediction of the course grade as of the updated prediction time, using the updated course-specific machine learning model.

14. The method of claim 13, further comprising:
generating the updated prediction of the course grade using actual enrollment feature values of the student that occurred between the prediction time and the updated prediction time.

15. The method of claim 10, wherein the course-specific machine learning model is trained including:
selecting at least one additional course in addition to the online course; and
training the course-specific machine learning model using the selected at least one additional course.

16. The method of claim 15, wherein the course-specific machine learning model is trained including:
selecting course comparison parameters for comparing the online course with a plurality of courses, including the at least one additional course;
selecting course-level features of the online course and the plurality of courses;
constructing a comparison model based on the course-level features;
predicting course-level feature values of the course level features for the online course, using the comparison model; and
selecting the at least one additional course, including comparing the predicted course-level feature values and corresponding feature values of the plurality of courses.

17. A system comprising:
at least one memory including instructions; and
at least one processor that is operably coupled to the at least one memory and that is arranged and configured to execute instructions that, when executed, cause the at least one processor to
determine a student in an online course, the online course occurring over a period of time, the online course including learning items and a grading structure used to grade at least some of the learning items;
determine a course-specific machine learning model trained using the grading structure and enrollment features characterizing student interactions with the learning items;
determine feature values of the enrollment features, based on student interactions of the student with the learning items as of a prediction time within the period of time; and
generate a prediction of a course grade of the student as of the prediction time for the online course, using the feature values and the course-specific machine learning model.

18. The system of claim 17, wherein the instructions, when executed, are further configured to cause the at least one processor to:
determine influential enrollment features on the predicted course grade;
determine influential feature values of the feature values, based on the influential enrollment features; and
generate a student support recommendation, based on the prediction of the course grade, the influential enrollment features, and the influential feature values.

19. The system of claim 17, wherein the instructions, when executed, are further configured to cause the at least one processor to:
train an updated course-specific machine learning model following the prediction, and prior to an updated prediction time; and
generate an updated prediction of the course grade as of the updated prediction time, using the updated course-specific machine learning model.

20. The system of claim 17, wherein the instructions, when executed, are further configured to cause the at least one processor to train the course-specific machine learning model including:
selecting at least one additional course in addition to the online course; and
training the course-specific machine learning model using the selected at least one additional course.
